(19) United States
(12) Patent Application Publication
(10) Pub. No.: US 2014/0094132 A1
(43) Pub. Date: Apr. 3, 2014

(54) METHODS AND ARRANGEMENTS FOR LOW POWER ACTIVE RADIO RECEPTION

(71) Applicants: Binuraj K. Ravindran, Cupertino, CA (US); Dongsheng Bi, Fremont, CA (US); Sridhar G. Sharma, Milpitas, CA (US)

(72) Inventors: Binuraj K. Ravindran, Cupertino, CA (US); Dongsheng Bi, Fremont, CA (US); Sridhar G. Sharma, Milpitas, CA (US)

(21) Appl. No.: 13/631,859

(22) Filed: Sep. 28, 2012

(51) Int. Cl. H04B 1/16

(52) U.S. Cl. CPC H04B 1/1615
USPC 455/182.1; 455/230

(57) ABSTRACT

Embodiments may comprise radio data system logic to enter a sleep mode and wake periodically to receive a data packet. In several embodiments, the data packet is a Radio Data System (RDS) packet and the radio data system logic is RDS logic. Further embodiments may comprise radio data system logic to process the data packet to determine a first type field and to parse the first type field to identify a first indication. In several embodiments, parsing the data packet by the radio data system logic comprises parsing the data packet to determine a program type field and parsing the program type field to identify the first indication as an emergency alert indication. In response to identifying the first indication as a trigger, many embodiments wake up NRSC-5 compliant, In-band on-channel (IBOC) radio logic to process an Active Radio message to output information associated with the first indication.

### BACKGROUND

The present disclosure relates generally to the field of radio reception technologies. More particularly, the present disclosure relates to low power active radio reception.

### BRIEF DESCRIPTION OF THE DRAWINGS

FIG. 1 depicts an embodiment of a wireless network comprising a plurality of communications devices, including multiple fixed or mobile communications devices;

FIG. 1A depicts an alternative embodiment of a transmitter for broadcasting emergency alerts;

FIG. 2 depicts an embodiment of a system/platform including a mobile device coupled with an In-Band on Channel (IBOC) and RDS receiver;

FIG. 3 depicts an embodiment of an apparatus for low power active radio reception; and

FIG. 4 depicts an embodiment of a flowchart for low power active radio reception.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives as defined by the appended claims. The detailed descriptions below are designed to make such embodiments understandable and obvious to a person having ordinary skill in the art.

Note that Radio Broadcasting Data System (RBDS) is the United States official name for the version of Radio Data System (RDS) implemented in the United States. RDS is very similar to RBDS but defines many features including how private (in-house) or other undefined features can be “packaged” in unused program groups. Herein the terms RDS and RBDS will be used interchangeably to refer to either RDS or RBDS, depending upon the governing protocol for a particular embodiment. Note also that while some embodiments may be specifically designed for RDS or RBDS, many embodiments may be designed for both RDS and RBDS.

Generally, embodiments for low power active radio reception are described herein. Embodiments may parse RDS data packets and parse data from these RDS data packets to determine when to wake up an IBOC radio receiver. A hybrid radio receiver may comprise an IBOC radio receiver capable of processing Active Radio messages and an FM (frequency modulation) receiver capable of processing RDS data packets. Many embodiments receive the first-alert, or the first emergency alert, through an RDS/RBDS channel instead of turning on the IBOC receiver and, thus, save active power. In these embodiments the first-alert, or the first emergency alert is first received through an RDS/RBDS channel because the RDS/RDBS receivers may be less complex and power-hungry relative to hybrid radio receivers. Several embodiments may comprise wake-up logic such as hardware and/or code for Radio Data System logic to enter a sleep mode and wake periodically to receive and process a RDS data packet and search for emergency alert notifications if any. In some embodiments, the data packet is an RBDS data packet and, in further embodiments, the data packet is an RDS data packet. In many embodiments, the Radio Data System logic may be designed to process both RBDS and RDS data packets.

Embodiments may comprise the radio data system logic to process the data packet to determine a first type field and to parse the first type field to identify a first indication. In several embodiments, parsing the data packet, by the radio data system logic, comprises parsing the data packet to determine a program type field and parsing the program type field to identify the first indication of an emergency alert indication.

In response to identifying the first indication, reception of AR packets obtained by parsing RDS packets acts as a trigger to wake NRSC-5 compliant, IBOC radio logic, many embodiments wake up the IBOC radio logic to process an Active Radio message to output information associated with the emergency alert to take advantage of a bandwidth for an IBOC channel with a hybrid radio receiver since the bandwidth on the RDS channel is limited compared with the IBOC channel. Furthermore, the higher bandwidth supported by the hybrid radio receiver allows broadcasting additional information about the alert compared to what is possible over the bandwidth-constrained RDS channel.

In further embodiments, waking up the IBOC radio logic comprises generating a wake signal to power up a Primary IBOC Data Service (PIDS) Logical Channel receiver to monitor Active Radio messages so the AR messages can be passed on to the AR monitoring and primary AR processing logic. And, in several embodiments, Active Radio messages are processed to determine more information about the emergency alert indication.

In further embodiments, the hybrid radio receiver may comprise control logic coupled with a database to determine whether an IBOC channel exists on the same frequency that the hybrid radio receiver is tuned to at the time when the emergency alert is detected on the RDS channel prior to waking up IBOC logic. In other embodiments, the PIDS channel logic may respond to the wake signal from the radio data system logic prior to the control logic determining whether an IBOC channel is available on the current frequency of the RDS channel. In some embodiments, the control logic may determine that the RF tuner should re-tune to a different frequency in response to determining either that the IBOC radio logic failed to detect an IBOC channel and/or the database determined that a different frequency for an IBOC channel is more suitable.

In some embodiments where there is a position location capability via GPS, Wi-Fi location or cellular location available then the database entries can have position information as well. In such embodiments, the control logic would determine the current position and determine the correct frequency at which the RF tuner should be tuned based upon the location of the hybrid radio receiver and the position information in the database. The database entries may be populated a priori with position information that may comprise, e.g., field strength measurements that are collected and embedded in the database or updated based on signal strength from past history by the control logic or by a another device such as via a database subscription service. And, in several embodiments, if the IBOC logic fails to detect an IBOC channel and the control logic determines that there are no further frequencies to re-tune to check for reception of an IBOC channel, the control logic may return to the frequency on which the emergency alert was detected through the RDS channel and instruct the radio data system logic to continue to output emergency messages via the RDS channel.

Various embodiments may be designed to address different technical problems associated with monitoring Active Radio messages. For instance, some embodiments may be designed to address one or more technical problems related to power requirements for monitoring Active Radio messages. The technical problem of power requirements for monitoring Active Radio messages may involve problems periodically waking IBOC radio logic to monitor and process Active Radio (AR) messages. In further embodiments, the technical problem may be that receiving emergency alerts in AR format in a battery-operated mobile hybrid radio receiver involves high power consumption to monitor the emergency alert messages at a periodic interval while, at the same time, maintaining a reasonable latency in receiving the emergency alerts. Emergency alerts may be rare but it is critical to flag the emergency alerts very quickly, i.e., with a low latency, so that the user can respond to the emergency alerts during the first critical moments of the emergency.

Technical problems such as one or more of the technical problems discussed above have not been known in the art until discovery and teaching represented by this disclosure. A lack of understanding of technical problems due in part to a lack of focus on mobile applications led to the failure of current art to conceive of, discuss, and describe the solutions such as the solutions described by this disclosure. In other words, the solutions presented herein were not obvious in the art due in part to a lack of focus on the technical problems by other persons of skill in the art. Also, the technical problems have been approached by only trying to solve power for a single standard, NRSC-5 (NRSC-5-C In-band/on-channel Digital Radio Broadcasting Standard, National Radio Systems Committee, September, 2011). This innovation uses two different technologies which coexist and uses the best aspects of both of these standards to reduce the power consumption, which is a key metric, associated with monitoring emergency alerts as a background task.

Different technical problems such as those discussed above may be addressed by one or more different embodiments. For instance, some embodiments that are designed to address power requirements for monitoring Active Radio messages may do so by one or more different technical means such as periodically waking a radio data system logic to monitor data packets such as RDS data packets and waking the IBOC radio logic to monitor and process Active Radio messages if the data packet received by the radio data system logic indicates a particular type field, a particular type of field, and/or a particular identification in the particular field such as an emergency alert indication. Furthermore, embodiments may address technical problems by implementing functionality of two standards, NRSC-5 and NRSC-4B (NRSC-4 National Radio Systems Committee United States RBDS Standard—Specification of the radio broadcast data system (RBDS), Consumer Electronics Association and National Association Of Broadcasters, April, 2011).

Radio data system logic such as RDS receivers may be a de facto standard in Hybrid Digital (HD) Radio™ receivers. RDS receivers are less complex, have faster acquisition times, higher sensitivity and have a very low power consumption compared to the IBOC radio logic, or HD Radio™ receivers. Furthermore, the faster acquisition time for RDS results in lower, active power consumption for the hybrid radio receiver. In fact, many embodiments receive the first-alert through an RDS channel instead of using an SIS indication on the IBOC PIDS channel and, thus, save active and stand-by power, as RDS/RDBS receivers are less complex and power-hungry compared to hybrid radio receivers.

Many embodiments may comprise NRSC-5 compliant hardware and code to receive IBOC broadcasts, commonly referred to as HD Radio™. Some embodiments may take advantage of Wireless Fidelity (Wi-Fi) network. Wi-Fi generally refers to devices that implement the IEEE 802.11-2007, IEEE Standard for Information technology—Telecommunications and information exchange between systems—Local and metropolitan area networks—Specific requirements—Part 11: Wireless LAN Medium Access Control (MAC) and Physical Layer (PHY) Specifications (http://standards.ieee.org/getieee802/download/802.11-2007.pdf) and other related wireless standards.

Several embodiments comprise servers, workstations, netbooks, mobile devices (Laptop, Smart Phone, Tablet, cellular phones, and the like) automobile equipment, or any other device that may benefit from inclusion of IBOC radio reception such as appliances. For example, a laptop, cellular phone, or refrigerator may include a display, a speaker, and a hybrid radio receiver to receive, e.g., emergency alert messages.

Logic, modules, devices, and interfaces herein described may perform functions that may be implemented in hardware and/or code. Hardware and/or code may comprise software, firmware, microcode, processors, state machines, chipsets, or combinations thereof designed to accomplish the functionality.

Embodiments may facilitate wireless communications. Some embodiments may comprise low power wireless communications like WiGig, Bluetooth®, wireless local area networks (WLANs), wireless metropolitan area networks (WMANs), wireless personal area networks (WPAN), cellular networks, communications in networks, messaging systems, and smart-devices to facilitate interaction between such devices. Furthermore, some wireless embodiments may incorporate a single antenna while other embodiments may employ dual antennas or other multiple antennas. For instance, multiple-input and multiple-output (MIMO) is the use of radio channels carrying signals via multiple antennas at both the transmitter and receiver to improve communication performance. Further embodiments may implement directional antennas or antenna arrays.

While some of the specific embodiments described below will reference the embodiments with specific configurations, those of skill in the art will realize that embodiments of the present disclosure may advantageously be implemented with other configurations with similar issues or problems.

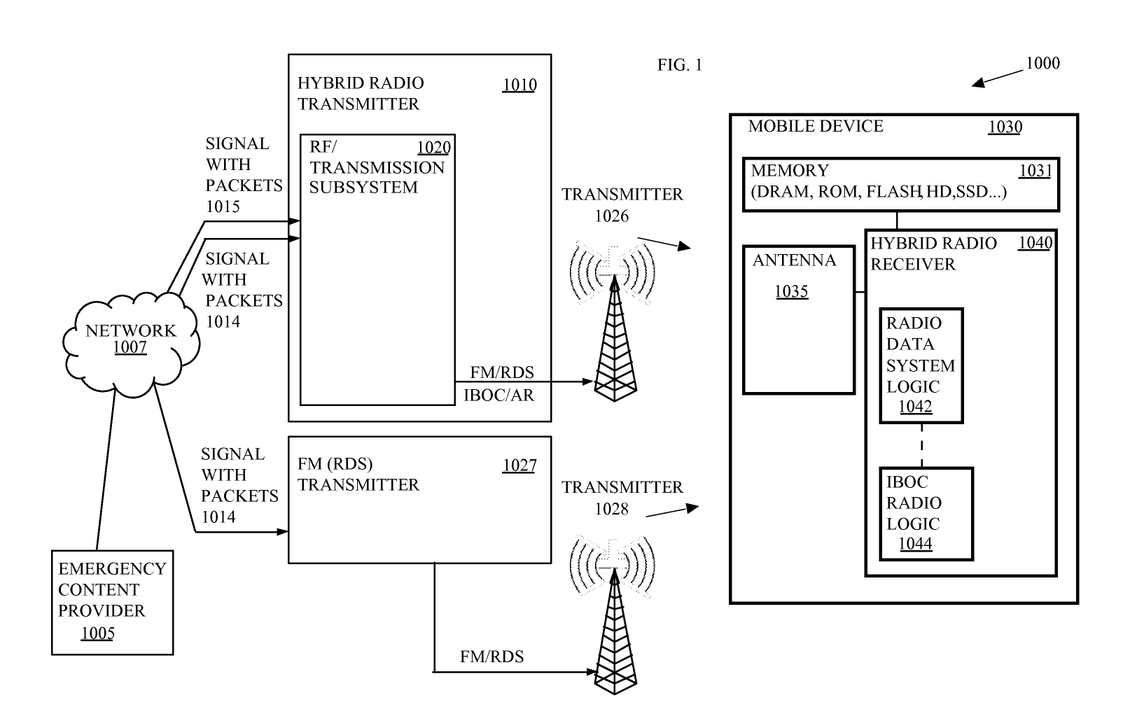

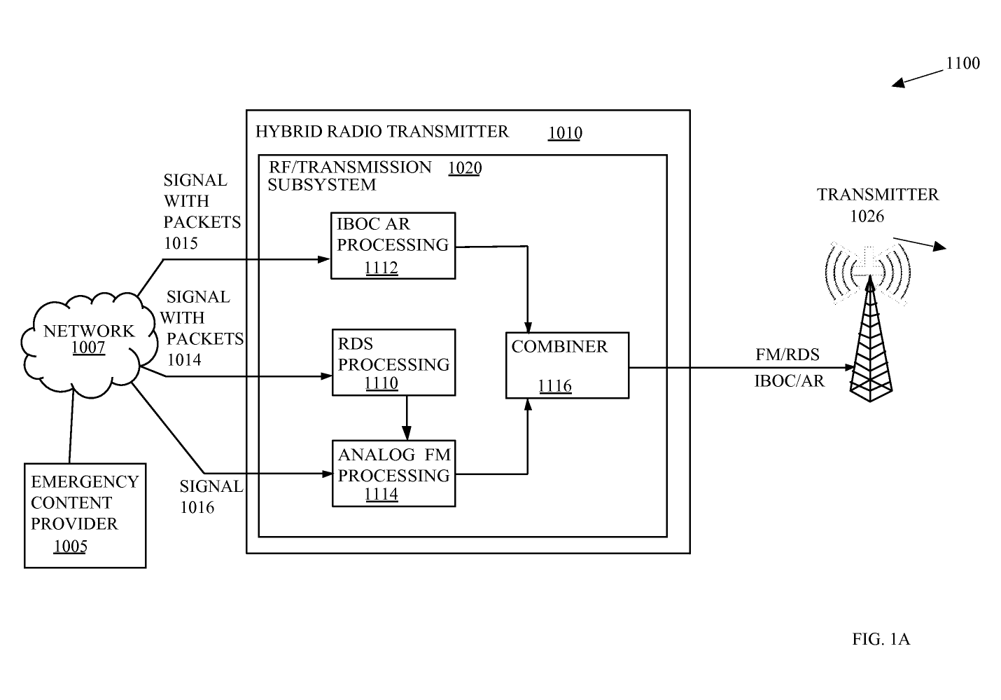

Turning now to FIG. 1, there is shown an embodiment of a wireless communication system 1000. The wireless communication system 1000 comprises an emergency content provider 1005 to transmit emergency content such as signals 1014 and 1015 through network 1007, to communications devices such as a hybrid radio transmitter 1010 and an FM/RDS transmitter 1027, for broadcasting digital audio and ancillary digital data signals over AM broadcast channels spaced 10 kHz apart that may contain analog amplitude modulated signals, and over FM broadcast channels spaced 200 kHz apart that may contain analog frequency modulated signals. The wireless communication system 1000 may deliver emergency alert notifications from local, state and federal agencies to the general public over different broadcast channels. For example, the emergency alert messages from the Federal Emergency Management Agency (FEMA) in the Common Alert Protocol (CAP) are received by Radio Broadcast Equipment of the hybrid radio transmitter 1010 and the FM/RDS transmitter 1027 via signals 1014 and 1015. The hybrid radio transmitter 1010 may receive the emergency alerts from the emergency content provider 1005 via signal 1015 and may broadcast the emergency alerts and other related time-critical and life-saving information over Hybrid Digital (HD) Radio™ technology using the Active Radio (AR) feature of NRSC-5 IBOC (In-Band on Channel) standard via transmitter 1026. And, the higher bandwidth supported by HD Radio™ allows broadcasting additional information about the alert compared to what is possible over the bandwidth-constrained RDS channel.

The FM/RDS transmitter 1027 may broadcast the emergency alert messages to the general public using the Radio Data System (RDS) channel simulcast with traditional Analog FM broadcasting via transmitter 1028. In many embodiments, the FM/RDS transmitter 1027 may broadcast the emergency alert messages via transmitter 1028 at a different carrier frequency than the carrier frequency on which the hybrid radio transmitter 1010 may broadcast the emergency alerts and other related time-critical and life-saving information via the transmitter 1026. FM and HD receivers such as a hybrid radio receiver 1040 of a mobile device 1030 can receive these emergency alerts although the FM receiver may be capable of receiving the RDS alerts and not be capable of receiving the AR alerts.

The communications device 1010 may rebroadcast the emergency alert messages by transmitting information from the signal with packets 1015 to a Radio Frequency (RF) transmission subsystem 1020. The RF transmission subsystem 1020 may comprise modulation logic and channel coding logic. The modulation logic and channel coding logic may encode and modulate a signal at a common frequency for both the IBOC and RDS channels. The encoded and modulated signals may then be broadcast via the transmitter 1026.

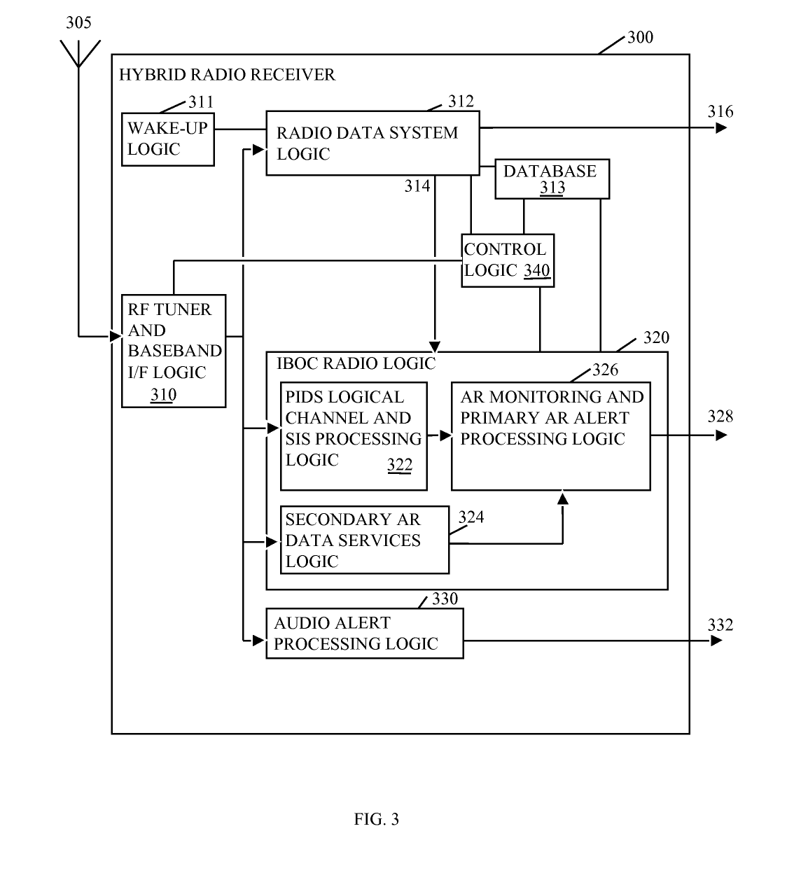

In an alternative embodiment illustrated in FIG. 1A, the hybrid radio transmitter 1010 may receive the emergency information from the emergency content provider for the RDS channel and the IBOC channel and may rebroadcast the emergency alert information via transmitter 1026 via an RDS channel and an IBOC channel. In particular, the RF/transmission subsystem 1020 may comprise RDS processing 1110 to process the messages such as Common Alert Protocol messages coming from Emergency Notification Server from the signal 1014 for RDS transmission, an IBOC AR processing 1112 to process messages such as Common Alert Protocol messages from signal 1015 for transmission, and analog frequency modulation (FM) processing 1114 to process the signal 1016 for transmission. The signal 1016 may typically comprise audio alerts or triggers to generate audio alerts through the analog FM channel. These audio alerts can be the source for generating audio alerts in the audio alert processing logic in a hybrid radio receiver such as the audio alert processing logic 330 in the receiver 300 illustrated in FIG. 3. The RDS processing 1110 may output a signal to the analog FM processing 1114 to combine with the FM signal to output to a combiner 1116. The RF/transmission subsystem 1020 may comprise the combiner 1116 to combine the outputs of the IBOC AR processing 1112 and the analog FM processing 1114 for transmission via transmitter 1026.

Referring again to FIG. 1, the mobile device 1030 may be designed or adapted to receive the RDS and/or IBOC radio transmission from the transmitter 1026. In many embodiments, the mobile device 1030 may comprises a portable electronics device such as a portable radio, a cellular phone, a laptop, a netbook, or any other device that may be designed to accommodate reception and communication of RDS and IBOC radio signals to a user. The mobile device 1030 may also include a battery or other energy storage device that can provide a limited amount of power to the mobile device 1030 without connection to a power source such as an electrical outlet. For example, the mobile device 1030 may be a smart phone and may operate on battery power for a particular number of hours in standby mode and a particular number of hours when operating.

The mobile device 1030 may comprise a memory 1031 that can be any one or more of a number of different types of volatile and non-volatile data storage devices such as random access memory such as Dynamic Random Access Memory (DRAM) buffers, registers, and cache; read only memory; flash memory; solid state drive; hard disk drive; optical drive; and/or the like. The memory 1031 may accommodate preferences, applications and other code, phonebooks, and the like. For instance, the memory 1031 may comprise a preference related to the time period a radio data system logic of the hybrid radio receiver may sleep or remain in stand-by mode before waking to check for events or triggers in data packets associated with waking up the hybrid radio receiver to receive AR messages. In many embodiments, the memory 1031 may comprise code to facilitate usage of a hybrid radio receiver 1040 and an antenna 1035 to receive and communicate to a user, information transmitted by the transmitter 1026 via the RDS and IBOC radio channels.

The hybrid radio receiver 1040 may comprise a radio frequency (RF) receiver. An RF receiver receives electromagnetic energy at an RF frequency and extracts the digital data via demodulation. The hybrid radio receiver 1040 may be compliant with the NRSC-5 IBOC (In-Band on Channel) standard also known as Hybrid Digital (HD) Radio™ (trademark of iBiquity Digital Corporation) to receive broadcasts of emergency alerts and other related time-critical and life-saving information over HD Radio™ technology. The hybrid radio receiver 1040 may also be compliant with an RBDS standard (NRSC-4-B—United States RBDS Standard, National Radio Systems Committee, April 2011) and/or the RDS standard, International Electrotechnical Commission (IEC) Radio Data System (RDS) standard version IEC 62106 Edition 2 (2009).

In many embodiments, the hybrid radio receiver 1040 may comprise radio data system logic 1042 and IBOC radio logic 1044. The radio data system logic 1042 may comprise logic to process data packets received via an RDS channel. In the present embodiment, wake-up logic may periodically wake up the radio data system logic 1042 to receive a data packet via the RDS channel from transmitter 1026. Such embodiments may reduce power consumption while monitoring for emergency alerts through the RDS channel. In many of these embodiments, the mobile device 1030 may comprise wake logic such as code to wake the radio data system logic 1042 a timed intervals, such as every ten seconds, and the period of the timed intervals may be stored as a preference in the memory 1031. In other embodiments, the hybrid radio receiver 1040 may comprise the wake logic to periodically wake the radio data system logic 1042. And in still further embodiments, the wake logic may reside partially in the hybrid radio receiver and partially in the mobile device 1030 outside of the hybrid radio receiver 1040.

In some embodiments, the hybrid radio receiver 1040 may be an optional attachment or accessory for the mobile device 1030 and, in some embodiments, the antenna 1035 may be integrated with the hybrid radio receiver 1040. In other embodiments, the hybrid radio receiver 1040 may be integrated with the mobile device 1030.

The radio data system logic 1042 may process RDS data packets by parsing the packets to determine field types within the data packets. For instance, the radio data system logic 1042 may be configured to parse the data packets to determine whether the data packets include a program type field. In several embodiments, the radio data system logic 1042 may respond to determining that the data packet includes a program type field by parsing the program type field to determine whether the field includes an emergency alert indication. Many embodiments may respond to determining that the program type field includes an emergency alert indication by waking up, or powering up, the IBOC radio logic 1044.

In response to waking the IBOC radio logic 1044, the IBOC radio logic 1044 may begin to receive and process broadcasts of emergency alerts and other related time-critical and life-saving information over Hybrid Digital (HD) Radio™ technology. The mobile device 1030 may then output and/or provide a user interface for a user to access the emergency alerts and other related time-critical and life-saving information.

In some embodiments, the antenna 1035 may be an antenna array comprising antenna elements. In further embodiments the antenna 1035 may comprise single, dual, or other number of antennas. An antenna array may be an array of individual, separately excitable antenna elements. The signals applied to the elements of the antenna cause the antenna to radiate spatial channels. Each spatial channel so formed may carry information.

The mobile device 1030 may depict a number of different embodiments including a Multiple-Input, Multiple-Output (MIMO) system with, e.g., four spatial streams, and may depict degenerate systems comprising a receiver and/or a transmitter with a single antenna including a Single-Input, Single Output (SISO) system, a Single-Input, Multiple Output (SIMO) system, and a Multiple-Input, Single Output (MISO) system.

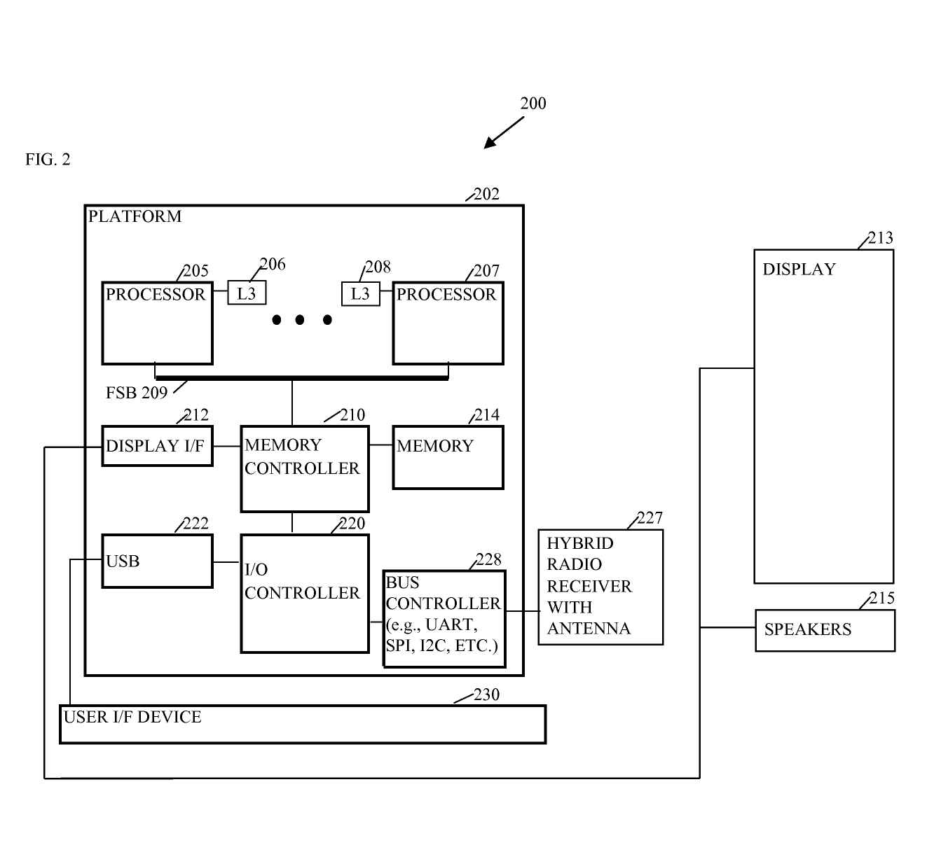

FIG. 2 depicts an embodiment of a system 200 including a platform 202 such as a laptop, Smartphone, car stereo, tablet, or other device that operates on battery power when disconnected from a power outlet and/or power from an electrical outlet. Platform 202 is adapted to accommodate an optional device connected to a bus controller 228 such as the hybrid radio receiver 227. In particular, the platform 202 may comprise a space and bus connection for the hybrid radio receiver 227 to plug into the bus connection. In other embodiments, the hybrid radio receiver 227 may be integrated with the platform 202 such as a chip or set of chips coupled with a printed circuit board built into the platform 202.

To illustrate, the platform 202 may comprise a car stereo that is capable of receiving AM channels, FM channels with emergency alerts, and IBOC channels with AR messages. The platform 202 may comprise a user interface device 230 that is either a button or is integrated with the display 213 and the speakers 215 may be the automobile speakers that sound both regular channel content and emergency alerts. In some embodiments, the platform 202 may mute regular content upon receiving an emergency alert and play the emergency alert as well as display text related to the emergency alert. In further embodiments, the platform 202 may power up the FM tuner periodically to check for emergency alerts and, in response to receipt of an emergency alert, power the amplifier for the speakers and sound the emergency alert through the speakers. In several embodiments, the platform 202 may power the amplifier only if the user appears to be present or the users' key has unlocked the ignition.

The hybrid radio receiver 227 may comprise an antenna integrated with the hybrid radio receiver 227 or coupled with the hybrid radio receiver 227 to receive RDS channel communications via radio data system logic and Active Radio (AR) messages via a high-bit rate data pipe using an IBOC Advance Application Service (AAS). The radio data system logic of the hybrid radio receiver 227 may alert IBOC radio logic about an emergency alert transmission using RDS. Once the hybrid radio receiver 227 detects emergency alerts over RDS channel, the radio data system logic may wake up or transmit a signal to wake up the IBOC radio logic to process AR messages.

In some embodiments, the battery operated mobile devices can take advantage of the fact that the AR alerts are available on the RDS channel and hence reduce the power consumption and improve stand-by time while operating off battery power. In some of these embodiments, the battery operated mobile devices, when connected to a power outlet, may monitor a low bitrate, low latency, Primary IBOC Data Service (PIDS) logical channel, Station Information Service (SIS) for primary alert information which indicates the AR transmission and then wake the AR processing logic to process AR messages if an emergency alert is received.

In the present embodiment, the hybrid radio receiver 227 may monitor for emergency alert by parsing the Program Type (PTY) field in RDS packets to search for emergency alert indications. There is a PTY field in each group and there are approximately 11 groups/second. During an emergency, the RDS encoder in the broadcaster will prioritize emergency alert packets over other RDS packets. In addition to the power savings from the faster acquisition by the radio data system logic, there are additional power savings from the reduced operating frequency required to demodulate less complex RDS packets. Thus, by separating the scanning for emergency alerts from the actual delivery of emergency information and by leveraging the best of both of the RDS and IBOC technologies, power consumption and hence the battery life can be significantly improved on the mobile radio broadcast hybrid radio receiver 227 that supports emergency alert reception.

Platform 202 may receive the emergency information from the AR messages at the bus controller 228 and transmit the information to an operating system (OS) designated processor such as processor 205 or 207 on the front-side bus (FSB) 209. Once the emergency information is received, bus controller 228 transfers the information to Input-Output (I/O) controller 220 in the form of one or more packets. The I/O controller 220 is adapted to receive inbound transactions from a variety of I/O devices, route the inbound transactions upbound to processors 205 and 207 via memory controller 210, and route outbound transactions received via the memory controller 210 to the corresponding I/O devices.

The bus controller 228 may comprise a bus controller such as a Universal Asynchronous Receiver/Transmitter (UART), a Serial Peripheral Interface Bus (SPI), an Inter-Integrated Circuit (I2C), etc. The platform 202 may also comprise other bus controllers such as a Peripheral Component Interconnect/Peripheral Component Interconnect-Extended (PCI/PCI-X) controller, or a peripheral device that is integrated with the platform 202.

The I/O controller 220 may couple with other I/O interfaces such as universal serial bus (USB) 222. USB 222 may handle data transfer from USB devices such as a user I/F device 230 such as a keyboard, trackball, mouse, hard drive, optical drive, tape drive, and the like.

The memory controller 210 may couple with memory 214 and a display I/F 212. The display I/F 212 may transmit emergency information to a display 212 and speakers 215 to communicate the emergency information to a user of the platform 202.

In some embodiments, a bus arbiter for FSB 209 may coordinate transmission across FSB 209 according to availability of the processors. The FSB 209 may be a front-side bus for processors 205 and 207 of platform 202. In other embodiments, the platform 202 may comprise high-speed, serial buses rather than an FSB. In further embodiments, the FSB 209 may represent interconnections between processor cores.

In some embodiments, the processors 205 and 207 may represent two or more processors. In further embodiments, each of the processors may comprise multiple processor cores. In other embodiments, the platform 202 may comprise a single processor and the processors 205 and 207 may represent a single or multiple cores rather than multiple processors.

FIG. 3 depicts an embodiment of an In-Band/On-Channel (IBOC) receiver 300 for low power active radio reception. More particularly, the hybrid radio receiver 300 may comprise radio data system logic 312 to alert the hybrid radio receiver 300 and specifically the IBOC radio logic 320 of the hybrid radio receiver 300 about an emergency alert transmission using the RDS channel, a cellular data network, or other network that utilizes less power than monitoring the Active Radio (AR) messages in Station Information Service (SIS) processing logic 322 available through Primary IBOC Data Service (PIDS) logical channel.

The primary emergency alert information indicating the basic information about the alerts is received over the PIDS logical channel and SIS processing logic 322. Secondary information and attachments for the alert, which may include maps or directions to nearest emergency shelters, may arrive on other logical channels via secondary AR data services logic 324. In addition this, there will be audio alerts as well via the audio alert processing logic 330.

In some embodiments, once the hybrid radio receiver 300 detects emergency alerts over the RDS channel or other data network channel, the rest of the decoding can continue via the IBOC radio logic 320. Receiving the emergency alert information over a lower-power RDS technology and switching over to IBOC for receiving more content rich emergency data can reduce the power consumption of the AR reception on battery-operated mobile devices. However, if the PIDS logical channel and SIS processing logic 322 is unable to detect an IBOC channel on the current frequency, the control logic 340 may determine whether there is another IBOC frequency to which the RF tuner and baseband I/F logic 310 should tune the hybrid radio receiver 300. If there is another frequency, the control logic 340 may instruct the RF tuner and baseband I/F logic 310 to re-tune to that frequency. If there is no other frequency for the IBOC channel, the control logic 340 may instruct the RF tuner and baseband I/F logic 310 return to the frequency on which the emergency alert was received via an RDS channel. The control logic 340 may instruct the radio data system logic 312 to continue processing the emergency alert messages and outputting those messages to a user I/F until further instruction is received from the user or another predetermined event occurs such as the platform is muted, powered off, the battery power reaches a threshold level, or the like.

In other embodiments, when the radio data system logic 312 determines that an emergency alert has been received, the radio data system logic 312 may communicate the occurrence to the control logic 340. In such embodiments, the control logic 340 may determine whether an IBOC channel is broadcast on the current frequency. If an IBOC channel is broadcast on the current frequency, the control logic 340 may instruct the PIDS logical channel and SIS processing logic 322 to detect the IBOC channel. If the PIDS logical channel and SIS processing logic 322 does detect the IBOC channel, the rest of the IBOC radio logic 320 may be powered up and may begin to receive AR messages with emergency alerts along with other related information. If the PIDS logical channel and SIS processing logic 322 does not detect the IBOC channel or there is no IBOC channel on the current frequency, the control logic 340 may instruct the RF tuner and baseband I/F logic 310 to re-tune to another available frequency for the IBOC channel if there is another frequency for an IBOC channel. If the RF tuner and baseband I/F logic 310 re-tunes to the new frequency and no IBOC channel is detected by the PIDS logical channel and SIS processing logic 322, the control logic 340 may instruct the RF tuner and baseband I/F logic 310 to re-tune to another available frequency for the IBOC channel. On the other hand, if no other frequency with an IBOC channel is available and the PIDS logical channel and SIS processing logic 322 failed to detect an IBOC channel, the control logic 340 may instruct the RF tuner and baseband I/F logic 310 return to the frequency on which the emergency alert was received via an RDS channel. The control logic 340 may instruct the radio data system logic 312 to continue processing the emergency alert messages and outputting those messages to a user I/F until further instruction is received from the user or another predetermined event occurs such as the platform is muted, powered off, the battery power reaches a threshold level, or the like

The hybrid radio receiver 300 may be an accessory such as a card to attach to a mobile device or may be integrated with a mobile device. In some embodiments, the hybrid radio receiver 300 comprises a system-on-chip (SoC). The SoC may comprise one or more of the elements described in the FIG. 3 including, in some embodiments, the antenna 305. For example, the SoC may comprise the radio data system logic 312. The SoC may comprise the radio data system logic 312 and the Radio Frequency (RF) tuner and Baseband interface (I/F) logic 310. The SoC may comprise the radio data system logic 312, the RF tuner and Baseband I/F logic 310, and the wake logic 311. The SoC may comprise one or more or all of the radio data system logic 312, the RF tuner and Baseband I/F logic 310, the wake logic 311, IBOC radio logic 320, and the audio alert processing logic 330. Any one or combination of two or more of any of the elements depicted in FIG. 3, as well as potentially other elements, may be included in SoC embodiments.

The hybrid radio receiver 300 may comprise RF tuner and Baseband I/F logic 310, wake-up logic 311, radio data system logic 312, IBOC logic 320, and audio alert processing logic 330. The RF tuner and Baseband I/F logic 310 may be an SoC designed for demodulating and decoding HD Radio™ signals. The RF tuner and Baseband I/F logic 310 may comprise an RF tuner including mixers and intermediate frequency (IF) amplifiers for amplitude modulation (AM) bands, frequency modulation (FM) bands, and weather (WX) bands, fully integrated voltage-controlled oscillator (VCO) and phase-locked loop (PLL) synthesizer, IF-processing including adaptive bandwidth control, stereo-decoder, RDS decoder, and digital interfaces for external HD Radio™ decoding on, e.g., a single integrated circuit in some embodiments.

The RF tuner and Baseband I/F logic 310 may comprise a base-band signal processor that includes an OFDM demodulator, error correction, and audio and data decoding of the digital channel. In some embodiments, the RF tuner and Baseband I/F logic 310 may be implemented in hardware. In further embodiments, the RF tuner and Baseband I/F logic 310 may be implemented with both hardware and code.

The RF tuner and Baseband I/F logic 310 may provide outputs for further processing including an output to radio data system logic 312 for, e.g., RDS processing; an output to IBOC radio logic 320 for IBOC processing; and an output to Audio alert processing logic 330 for audio processing. For instance, the wake logic 311 may wake up the radio data system logic 312 and, in some embodiments, also the RF tuner and Baseband I/F logic 310 periodically, at preset intervals, or at predetermined time periods to facilitate operation of the radio data system logic 312 to check for particular events that trigger further action.

The radio data system logic 312 may be an RDBS signal processor, intended for recovering the inaudible RDS information transmitted on most FM radio broadcasting stations. The radio data system logic 312 may comprise sampling logic, analog-to-digital (A/D) conversion, demodulation, decoding, error detection, and possibly other functionality. In some embodiments, after filtering a highly oversampled output of an A/D converter, an RDS demodulator may extract a data clock, a data signal, and quality information. In further embodiments, a decoder may synchronize a bit wise data stream to group and block information. This processing may include an error detection and error correction algorithm.

The radio data system logic 312 may parse the group and block information to identify a particular event that acts as a trigger. For example, the inclusion of a specific field type or a specific indication in a field may be an event that acts as a trigger. The specific field type may include, for instance, a program type field and the specific indication in the field may comprise an emergency alert. In response to the occurrence of an event that triggers further action, the radio data system logic 312 may output a wake up signal 314 to wake up part or all of the logic of the IBOC radio logic 320. In some embodiments, the radio data system logic 312 may output the event or an indication of the event to a user interface via output 316 such as to a display on a cell phone or a computer.

The IBOC radio logic 320 may receive and process data from layer 1 logical channels to determine layer 2 protocol data units (PDUs). Layer 2 enables the HD Radio system to support transport services comprising a Main Program Service (MPS), a Supplemental Program Service (SPS), an Advanced Application Services (AAS), and a Station Information Service (SIS). The MPS may include a Main Program Service Audio (MPSA) and may also include a Main Program Service Data (MPSD). MPS PDUs may be generated by the Audio Transport and encapsulate both MPSA and MPSD information.

The SPS may provide the broadcaster the option of multiplexing additional programs with the MPS. The SPS may comprise a Supplemental Program Service Audio (SPSA) and may also include a Supplemental Program Service Data (SPSD). SPS PDUs may be generated by the same Audio Transport as the MPS PDUs.

The AAS may provide the broadcaster the option of multiplexing additional types of content, other than SPS, along with the MPS. The AAS may provide the packet transport mechanism to perform the framing and the encapsulation of the data packets. Two types of methods for multiplexing AAS data into a Layer 2 PDU may comprise fixed and opportunistic. Fixed data may reserve a fixed amount of bandwidth by scaling back the bandwidth allocation of the MPS, and the opportunistic data makes use of any unused bandwidth due to variability of both the MPS and SPS.

The IBOC radio logic 320 may receive different components of Active Radio (AR) messages such as emergency alerts are transmitted over multiple IBOC logical channels. The primary emergency alert information indicating the basic information about the alerts is received over PIDS logical channels as part of Station Information Service (SIS). The emergency alerts over RDS and IBOC channels may occur on the same frequency or on a different frequency. The hybrid radio receiver 300 may maintain a database 313 of frequencies that transmit emergency alert messages over RDS channels and over IBOC channels.

In several embodiments, the database 313 of frequencies that transmit emergency alert messages over RDS channels and over IBOC channels may be maintained using the location information which is readily available in, e.g., a cell phone, and may be available in, e.g., a laptop. In some embodiments, the RDS and IBOC emergency alerts may be broadcast on the same FM frequency. In other embodiments, the RDS and IBOC emergency alerts may be broadcast on different frequencies. In many embodiments, the database 313 may contain information on the best frequency to tune to receive IBOC emergency alerts. For instance, the database 313 may maintain a record or history of signal strength indications for various IBOC channels at different locations proximate to an area about locations for which the hybrid radio receiver 300 may reside if primarily stationary or travel if mobile. In further embodiments, the database 313 may maintain records of outages for IBOC channels, significant changes in received signal strength, signal-to-noise ratios to identify IBOC channels that may be on frequencies prone to interference in various locations or at various times, or any other indicator related to determining the best frequency, wherein the “best” frequency may be the frequency that is most likely to be received and/or be a reliable source for emergency alerts and/or associated information.

The IBOC radio logic 320 may comprise PIDS logical channel and SIS processing logic 322, AR monitoring and primary AR alert processing logic 326, and secondary AR data services logic 324. The PIDS logical channel and SIS processing logic 322 may process the SIS PDUs to determine AR messages and output the AR messages to the AR monitoring and primary AR alert processing logic 326.

The AR monitoring and primary AR alert processing logic 326 may also receive other types of data associated with the AR messages via the secondary AR data services logic 324. In many embodiments, the AR monitoring and primary AR alert processing logic 326 may output the AR messages to a user interface via output 328 such as to a display on a cell phone or a computer.

The audio alert processing logic 330 may process and output audio related to AR messages to a user interface via output 328 such as to a speaker on a cell phone or a laptop.

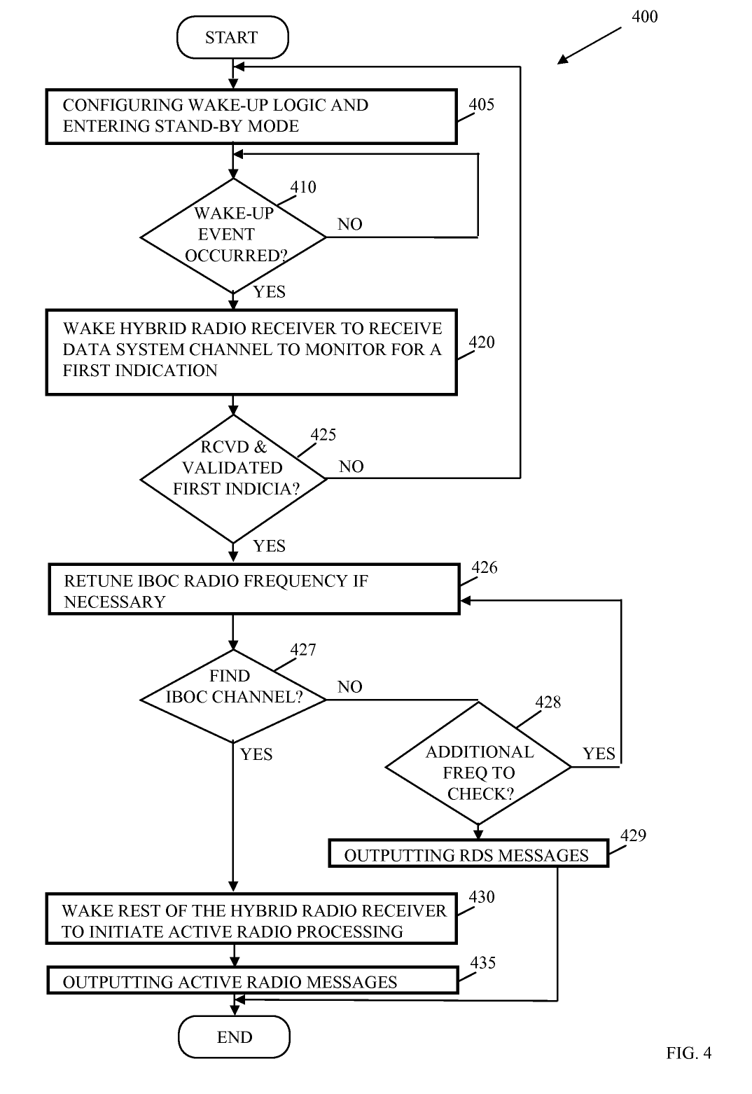

FIG. 4 depicts an embodiment of a flowchart 400 for low power active radio reception. The flow chart 400 begins with configuring wake-up logic and entering stand-by mode (element 405). Some embodiments may comprise wake-up logic either as part of the hybrid radio receiver or outside of the hybrid radio receiver in, e.g., an operation system, an application executing on an operating system, or an embedded code executing concurrently with an operating system. The wake-up logic may be configured to place logic of the hybrid radio receiver into a low power consumption mode such as a stand-by mode and then to periodically wake the radio data system logic to monitor data packets (element 410)

When the wake-up event occurs, the wake-up logic may wake up or power up the radio data system logic to monitor data packets such as RDS data packets for a first indication such as an indication that is an event or trigger to wake the IBOC radio logic (element 420). The hybrid radio receiver may then continue to periodically decode and monitor the data packets for a wake-up event or trigger to wake the IBOC radio logic. For instance, the radio data system logic may monitor data packets for a trigger such as the inclusion of a field type or an indication in a particular field. If the event is not found in the data packets or not found within a particular period of time or a predetermined period of time, the wake logic, the hybrid radio receiver, or the radio data system logic may comprise logic to place the radio data system logic back into the stand-by mode until a subsequent wake interval (element 425).

In response to identifying the event or trigger in the data packets, control logic 426 may determine whether to re-tune to another frequency or to check for the IBOC channel on the current frequency. Once the frequency is confirmed or re-tuned, the IBOC radio logic may determine whether the IBOC channel can be detected and if an AR message can be parsed from the signal on the IBOC channel (element 427). If the channel is not detected or the AR message relating to the emergency alert is not detected then the control logic may determine whether there are additional frequencies with IBOC channels to check (element 428).

If there are additional frequencies to check, the control logic may re-tune to receive another frequency for an IBOC channel (element 426). If there is no other frequencies for IBOC channels, the control logic may determine that the hybrid radio receiver should output emergency alert messages from the RDS channel on which the first alert was received.

If an AR message is detected by the PIDS logical channel and processing logic, then the radio data system logic may comprise logic to generate a wake signal to wake up or power up IBOC radio logic to initiate active radio processing (element 430). For instance, if the radio data system logic identifies a program type field and an indication of an emergency alert in the program type field of an RDS data packet, the radio data system logic may generate a wake-up signal to activate Active Radio (AR) processing.

Active Radio processing may produce enhanced information related to the emergency alert such as maps or directions to nearest emergency shelters, photos, Internet links to news stories or further information, streaming video, links to photos or video sources, or any other type of information related to the alert. The IBOC radio logic may then output the AR messages (element 435) and, in some embodiments, secondary information related to the AR messages.

The following examples pertain to further embodiments. One example comprises a method. The method may involve receiving, by radio data system logic, a data packet; parsing the data packet, by the radio data system logic, to determine a first type field and parsing the first type field to identify a first indication; waking up In-band on-channel (IBOC) radio logic to monitor Active Radio messages in response to identifying the first indication as a trigger to wake up the IBOC radio logic; and processing an Active Radio message to output information associated with the first indication.

Some embodiments may further comprise periodically waking the radio data system logic to receive data packets. In further embodiments, receiving the data packet comprises receiving, via an antenna and a hybrid radio receiver, an RDS packet. In some embodiments, parsing the data packet, by radio data system logic comprises parsing the RDS packet by the radio data system logic. In some embodiments, parsing the data packet, by the radio data system logic, comprises parsing the data packet to determine a program type field. In some embodiments, parsing the data system packet, by the radio data system logic, comprises parsing a program type field to identify the first indication as an emergency alert indication. In some embodiments of the method, waking up the IBOC radio logic comprises transmitting a wake signal to power up a Primary IBOC Data Service (PIDS) Logical Channel receiver to monitor Active Radio messages. And some embodiments further comprise determining, by control logic, whether a current frequency comprises an IBOC channel, that the IBOC radio logic does not detect an IBOC channel, whether another frequency comprises an IBOC channel, to instruct an RF tuner and baseband logic to re-tune to another frequency with an IBOC channel, or to instruct the radio data system logic to continue to output emergency alerts in response to a determination that the IBOC radio logic cannot detect an IBOC channel.

At least one computer program product for communication of a packet with a short frame, the computer program product comprising a computer useable medium having a computer useable program code embodied therewith, the computer useable program code comprising computer useable program code configured to perform operations, the operations to carry out a method according to any one or more or all of embodiments of the method described above.

At least one system comprising hardware and code may carry out a method according to any one or more or all of embodiments of the method described above.

Another example comprises an apparatus. The apparatus may comprise a radio data system logic to receive a data packet, to parse the data packet to determine a first type field, to parse the first type field to identify a first indication; and to wake up In-band on-channel (IBOC) radio logic to monitor Active Radio messages in response to identifying the first indication as a trigger to wake up the IBOC radio logic; and IBOC radio logic to process an Active Radio message to output information associated with the first indication in response to identification of the first indication by the radio data system logic.

Some embodiments further comprise wake-up logic to periodically waking the radio data system logic to receive data packets. In some embodiments, the radio data system logic comprises logic to parse the data packet to receive an RDS packet. In further embodiments, the radio data system logic comprises logic to parse an RDS packet. In some embodiments, the logic to parse an RDS packet comprises logic to parse the data packet to determine a program type field. In some embodiments, the logic to parse an RDS packet comprises logic to parse a program type field to identify the first indication as an emergency alert indication. In further embodiments, the radio data system logic to wake up the IBOC logic comprises logic to transmit a wake signal to power up a Primary IBOC Data Service (PIDS) Logical Channel receiver to monitor Active Radio messages.

Some embodiments further comprise control logic to determine whether a current frequency comprises an IBOC channel, to determine that the IBOC radio logic does not detect an IBOC channel, to determine whether another frequency comprises an IBOC channel, to instruct an RF tuner and baseband logic to re-tune to another frequency with an IBOC channel, or to instruct the radio data system logic to continue to output emergency alerts in response to a determination that the IBOC radio logic cannot detect an IBOC channel.

Another example comprises a system. The system may comprise at least one system comprising the apparatus according to any one or more of or all of the elements above and comprising an antenna.

Another example comprises a system. The system may comprise an antenna; an Hybrid radio receiver coupled with the antenna, the hybrid radio receiver comprising: a radio data system logic to receive a data packet, to parse the data packet to determine a first type field, to parse the first type field to identify a first indication; and to wake up In-band on-channel (IBOC) radio logic to monitor Active Radio messages in response to identifying the first indication as a trigger to wake up the IBOC radio logic; and IBOC radio logic to process an Active Radio message to output information associated with the first indication.

In some embodiments, the hybrid radio receiver comprises wake-up logic to periodically waking the radio data system logic to receive data packets. In some embodiments, the radio data system logic comprises logic to parse the data packet to receive an RDS packet. In some embodiments, the radio data system logic comprises logic to parse an RDS packet. In some embodiments, the logic to parse an RDS packet comprises logic to parse the data packet to determine a program type field. In some embodiments, the logic to parse an RDS packet comprises logic to parse a program type field to identify the first indication as an emergency alert indication. In further embodiments, the radio data system logic to wake up the IBOC logic comprises logic to transmit a wake signal to power up a Primary IBOC Data Service (PIDS) Logical Channel receiver to monitor Active Radio messages.

Some embodiments further comprise control logic to determine whether a current frequency comprises an IBOC channel, to determine that the IBOC radio logic does not detect an IBOC channel, to determine whether another frequency comprises an IBOC channel, to instruct an RF tuner and baseband logic to re-tune to another frequency with an IBOC channel, or to instruct the radio data system logic to continue to output emergency alerts in response to a determination that the IBOC radio logic cannot detect an IBOC channel.

At least one computer program product for communication of a packet with a frame, the computer program product comprising a computer useable medium having a computer useable program code embodied therewith, the computer useable program code comprising computer useable program code configured to perform operations, the operations to carry out parsing a data packet, by the radio data system logic, to determine a first type field and parsing the first type field to identify a first indication; waking up In-band on-channel (IBOC) radio logic to monitor Active Radio messages in response to identifying the first indication as a trigger to wake up the IBOC radio logic; and processing an Active Radio message to output information associated with the first indication.

Some embodiments further comprise periodically waking the radio data system logic to receive data packets. Some embodiments further comprise receiving the data packet comprises receiving, via an antenna and a hybrid radio receiver, as the data packet, an RDS packet. In further embodiments, parsing the data packet, by radio data system logic comprises parsing the RDS packet by the radio data system logic. In further embodiments, parsing the data packet, by the radio data system logic, comprises parsing the data packet to determine a program type field. In some embodiments, parsing the data system packet, by the radio data system logic, comprises parsing a program type field to identify the first indication as an emergency alert indication. In some embodiments, waking up the IBOC radio logic comprises transmitting a wake signal to power up a Primary IBOC Data Service (PIDS) Logical Channel receiver to monitor Active Radio messages. And some embodiments further comprise determining, by control logic, whether a current frequency comprises an IBOC channel, that the IBOC radio logic does not detect an IBOC channel, whether another frequency comprises an IBOC channel, to instruct an RF tuner and baseband logic to re-tune to another frequency with an IBOC channel, or to instruct the radio data system logic to continue to output emergency alerts in response to a determination that the IBOC radio logic cannot detect an IBOC channel

In some embodiments, some or all of the features described above and in the claims may be implemented in one embodiment. For instance, alternative features may be implemented as alternatives in an embodiment along with logic or selectable preference to determine which alternative to implement. Some embodiments with features that are not mutually exclusive may also include logic or a selectable preference to activate or deactivate one or more of the features. For instance, some features may be selected at the time of manufacture by including or removing a circuit pathway or transistor. Further features may be selected at the time of deployment or after deployment via logic or a selectable preference such as a dipswitch, a one-time programmable (OTP) memory, e-fuse, or the like. A user may select still further features after deployment via a selectable preference such as a software preference, a one-time programmable (OTP) memory, a dipswitch, or the like.

Another embodiment is implemented as a program product for implementing systems, apparatuses, and methods described with reference to FIGS. 1-4. Embodiments can take the form of an entirely hardware embodiment, a software embodiment implemented via general purpose hardware such as one or more processors and memory, or an embodiment containing both specific-purpose hardware and software elements. One embodiment is implemented in software or code, which includes but is not limited to firmware, resident software, microcode, or other types of executable instructions.

Furthermore, embodiments can take the form of a computer program product accessible from a machine-accessible, computer-usable, or computer-readable medium providing program code for use by or in connection with a computer, mobile device, or any other instruction execution system. For the purposes of this description, a machine-accessible, computer-usable, or computer-readable medium is any apparatus or article of manufacture that can contain, store, communicate, propagate, or transport the program for use by or in connection with the instruction execution system or apparatus.

The medium may comprise an electronic, magnetic, optical, electromagnetic, or semiconductor system medium. Examples of a machine-accessible, computer-usable, or computer-readable medium include memory such as volatile memory and non-volatile memory. Memory may comprise, e.g., a semiconductor or solid-state memory like flash memory, magnetic tape, a removable computer diskette, a random access memory (RAM), a read-only memory (ROM), a rigid magnetic disk, and/or an optical disk. Current examples of optical disks include compact disk-read only memory (CD-ROM), compact disk-read/write memory (CD-R/W), digital video disk (DVD)-read only memory (DVD-ROM), DVD-random access memory (DVD-RAM), DVD-Recordable memory (DVD-R), and DVD-read/write memory (DVD-R/W).

An instruction execution system suitable for storing and/or executing program code may comprise at least one processor coupled directly or indirectly to memory through a system bus. The memory may comprise local memory employed during actual execution of the code, bulk storage such as dynamic random access memory (DRAM), and cache memories which provide temporary storage of at least some code in order to reduce the number of times code must be retrieved from bulk storage during execution.

Input/output or I/O devices (including but not limited to keyboards, displays, pointing devices, etc.) can be coupled to the instruction execution system either directly or through intervening I/O controllers. Network adapters may also be coupled to the instruction execution system to enable the instruction execution system to become coupled to other instruction execution systems or remote printers or storage devices through intervening private or public networks. Modem, WiGig, Bluetooth™, Ethernet, Wi-Fi, and WiDi adapter cards are just a few of the currently available types of network adapters.

What is claimed is:

1. A method comprising:
receiving, by radio data system logic, a data packet;
parsing the data packet, by the radio data system logic, to determine a first type field and parsing the first type field to identify a first indication;
waking up In-band on-channel (IBOC) radio logic to monitor Active Radio messages in response to identifying the first indication as a trigger to wake up the IBOC radio logic; and
processing an Active Radio message to output information associated with the first indication.

2. The method of claim 1, further comprising periodically waking the radio data system logic to receive data packets.

3. The method of claim 1, further comprising determining, by control logic, whether a current frequency comprises an IBOC channel, that the IBOC radio logic does not detect an IBOC channel, whether another frequency comprises an IBOC channel, to instruct an RF tuner and baseband logic to re-tune to another frequency with an IBOC channel, or to instruct the radio data system logic to continue to output emergency alerts in response to a determination that the IBOC radio logic cannot detect an IBOC channel.

4. The method of claim 1, further comprising determining, by control logic, to instruct an RF tuner and baseband logic to re-tune to another frequency with an IBOC channel, wherein the other frequency is selected from a database of frequencies with IBOC channels based upon position information, wherein the database comprises information to identify the best frequency to tune into to receive IBOC emergency alerts.

5. The method of claim 1, wherein receiving the data packet comprises receiving, via an antenna and a hybrid radio receiver, a Radio Data System (RDS) packet.

6. The method of claim 5, wherein parsing the data packet, by radio data system logic comprises parsing the RDS packet by the radio data system logic.

7. The method of claim 1, wherein parsing the data packet, by the radio data system logic, comprises parsing the data packet to determine a program type field and parsing a program type field to identify the first indication as an emergency alert indication.

8. The method of claim 1, wherein waking up the IBOC radio logic comprises generating a wake signal to power up a Primary IBOC Data Service (PIDS) Logical Channel receiver to monitor Active Radio messages.

9. An apparatus comprising:
a radio data system logic to receive a data packet, to parse the data packet to determine a first type field, to parse the first type field to identify a first indication; and to wake up In-band on-channel (IBOC) radio logic to monitor Active Radio messages in response to identifying the first indication as a trigger to wake up the IBOC radio logic; and
IBOC radio logic to process an Active Radio message to output information associated with the first indication in response to identification of the first indication by the radio data system logic.

10. The apparatus of claim 9, further comprising wake-up logic to periodically waking the radio data system logic to receive data packets.

11. The apparatus of claim 9, further comprising control logic to determine whether a current frequency comprises an IBOC channel, to determine that the IBOC radio logic does not detect an IBOC channel, to determine whether another frequency comprises an IBOC channel, to instruct an RF tuner and baseband logic to re-tune to another frequency with an IBOC channel, or to instruct the radio data system logic to continue to output emergency alerts in response to a determination that the IBOC radio logic cannot detect an IBOC channel.

12. The apparatus of claim 9, wherein the radio data system logic comprises logic to parse the data packet to receive a Radio Data System (RDS) packet.

13. The apparatus of claim 9, wherein the radio data system logic comprises logic to parse a Radio Data System (RDS) packet.

14. The apparatus of claim 13, wherein the logic to parse a Radio Data System (RDS) packet comprises logic to parse the data packet to determine a program type field.

15. The apparatus of claim 14, wherein the logic to parse a Radio Data System (RDS) packet comprises logic to parse a program type field to identify the first indication as an emergency alert indication.

16. The apparatus of claim 9, wherein the radio data system logic to wake up the IBOC logic comprises logic to generate a wake signal to power up a Primary IBOC Data Service (PIDS) Logical Channel receiver to monitor Active Radio messages.

17. A system comprising:
an antenna;
an hybrid radio receiver coupled with the antenna, the hybrid radio receiver comprising:
a radio data system logic to receive a data packet, to parse the data packet to determine a first type field, to parse the first type field to identify a first indication; and to wake up In-band on-channel (IBOC) radio logic to monitor Active Radio messages in response to identifying the first indication as a trigger to wake up the IBOC radio logic; and
IBOC radio logic to process an Active Radio message to output information associated with the first indication.

18. The system of claim 17, wherein the hybrid radio receiver comprises wake-up logic to periodically waking the radio data system logic to receive data packets.

19. The system of claim 17, wherein the radio data system logic comprises logic to parse the data packet to receive a Radio Data System (RDS) packet.

20. The system of claim 17, wherein the radio data system logic comprises logic to parse a Radio Data System (RDS) packet.

21. The system of claim 20, wherein the logic to parse a Radio Data System (RDS) packet comprises logic to parse the data packet to determine a program type field.

22. The system of claim 21, wherein the logic to parse a Radio Data System (RDS) packet comprises logic to parse a program type field to identify the first indication as an emergency alert indication.

23. The system of claim 17, wherein the radio data system logic to wake up the IBOC logic comprises logic to generate a wake signal to power up a Primary IBOC Data Service (PIDS) Logical Channel receiver to monitor Active Radio messages.

24. A computer program product for low power active radio reception, the computer program product comprising:
a computer useable medium having a computer useable program code embodied therewith, the computer useable program code comprising computer useable program code configured to perform operations, the operations comprising:
receiving, by radio data system logic, a data packet;
parsing the data packet, by the radio data system logic, to determine a first type field and parsing the first type field to identify a first indication;
waking up In-band on-channel (IBOC) radio logic to monitor Active Radio messages in response to identifying the first indication as a trigger to wake up the IBOC radio logic; and
processing an Active Radio message to output information associated with the first indication.

25. The computer program product of claim 24, further comprising periodically waking the radio data system logic to receive data packets.

26. The computer program product of claim 24, further comprising receiving, via an antenna and a hybrid radio receiver, as the data packet, a Radio Data System (RDS) packet.

27. The computer program product of claim 26, wherein parsing the data packet, by radio data system logic comprises parsing the RDS packet by the radio data system logic.

28. The computer program product of claim 24, wherein parsing the data packet, by the radio data system logic, comprises parsing the data packet to determine a program type field.

29. The computer program product of claim 24, wherein parsing the data system packet, by the radio data system logic, comprises parsing a program type field to identify the first indication as an emergency alert indication.

30. The computer program product of claim 24, wherein waking up the IBOC radio logic comprises generating a wake signal to power up a Primary IBOC Data Service (PIDS) Logical Channel receiver to monitor Active Radio messages.
